(19) United States
(12) Patent Application Publication
(10) Pub. No.: US 2009/0326761 A1
(43) Pub. Date: Dec. 31, 2009

(54) VEHICLE CONTROL DEVICE

(75) Inventor: Chihiro Nitta, Chita-gun (JP)

Correspondence Address: SUGHRUE MION, PLLC, 2100 PENNSYLVANIA AVENUE, N.W., SUITE 800, WASHINGTON, DC, 20037, US

(73) Assignee: ADVICS CO., LTD., Kariya-city (JP)

(21) Appl. No.: 12/481,367

(22) Filed: Jun. 9, 2009

(30) Foreign Application Priority Data
Jun. 26, 2008 (JP) 2008-167616

(51) Int. Cl. B62D 6/00

(52) U.S. Cl. 701/41

(57) ABSTRACT

A vehicle control device includes a turning state changing mechanism for changing a turning state of a vehicle on the basis of a turning state changing command, and a curve-driving assessment portion for inputting therein a curve characteristic information including a shape of a curve existing in a traveling direction of the vehicle and a line-of-sight information relating to a line-of-sight of a driver and for outputting the turning state changing command to the turning state changing mechanism on the basis of the curve characteristic information and the line-of-sight information.

### CROSS REFERENCE TO RELATED APPLICATIONS

This application is based on and claims priority under 35 U.S.C. § 119 to Japanese Patent Application 2008-167616, filed on Jun. 26, 2008, the entire contents of which is incorporated herein by reference.

### FIELD OF THE INVENTION

The present invention relates to a vehicle control device having a turning state changing mechanism for changing a turning state of a vehicle on the basis of a turning state changing command.

### BACKGROUND

Disclosed in JPH8-159787A is a steering control device for a vehicle including a map information outputting means for outputting a map information including a road on which the vehicle travels, a vehicle position detecting means for detecting a vehicle position on the map, a steering means for steering a steered wheel of the vehicle, a steering torque applying means for applying a steering torque to the steering means, and a control means for calculating a deviation between an azimuth angle changing amount of the road on which the vehicle travels and an azimuth angle changing amount of the vehicle and driving the steering torque applying means in a direction in which the deviation is decreased. In the steering control device, disclosed in JPH8-159787A, the azimuth angle changing amount of the road, which is calculated from the map information and the vehicle position, is compared with the azimuth angle changing amount of the vehicle. In a case where the deviation between the azimuth angle changing amount of the road and the azimuth angle changing amount of the vehicle exists, the steering control device determines that the vehicle may deviate from the road. Accordingly, the steering control device applies the steering torque to the steering means so as to decrease the deviation. As a result, according to the steering control device of JPH8-159787A, a possibility of the vehicle deviating from the road may be decreased even in a case where a driving capability of a driver is decreased or insufficient.

In the steering control device disclosed in JPH8-159787A, the azimuth angle changing amount of the road, on which the vehicle travels, and the azimuth angle changing amount of the vehicle are used as input information, so that the steering torque is applied to the steering means so as to decrease the difference between the azimuth angle changing amount of the road and the azimuth angle changing amount of the vehicle. Therefore, the vehicle may appropriately be controlled in a case where the driver drives the vehicle normally (conscientiously). However, in a case where the driver has preference for sporty driving and drives the vehicle specifically so as to curve along an extremely “out-in-out” line, the steering torque may unexpectedly be applied to the steering means, which may cause a discomfort to the driver.

A need thus exists to provide a vehicle control device which is not susceptible to the drawback mentioned above.

### SUMMARY OF THE INVENTION

According to an aspect of the present invention, a vehicle control device includes a turning state changing mechanism for changing a turning state of a vehicle on the basis of a turning state changing command, and a curve-driving assessment means for inputting therein a curve characteristic information including a shape of a curve existing in a traveling direction of the vehicle and a line-of-sight information relating to a line-of-sight of a driver and for outputting the turning state changing command to the turning state changing mechanism on the basis of the curve characteristic information and the line-of-sight information.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a diagram schematically illustrating a vehicle to which a vehicle control device according to a first embodiment is provided;

FIG. 2 is a functional block diagram of the vehicle control device;

FIG. 3 is a functional block diagram illustrating a configuration of a line-of-sight detecting device;

FIG. 4 is a diagram for explaining a relationship between a fixation point reference line and a fixation point;

FIG. 5 is a flowchart illustrating an example of a control process executed at the vehicle control device;

FIG. 6 is a diagram schematically illustrating a vehicle to which a vehicle control device according to a second embodiment is provided;

FIG. 7 is a diagram schematically illustrating a vehicle to which a vehicle control device according to a third embodiment is provided; and

FIG. 8 is a diagram schematically illustrating a vehicle to which a vehicle control device according to a fourth embodiment is provided.

### DETAILED DESCRIPTION

Embodiments of a vehicle control device will be described below in accordance with the attached drawings.

### First Embodiment

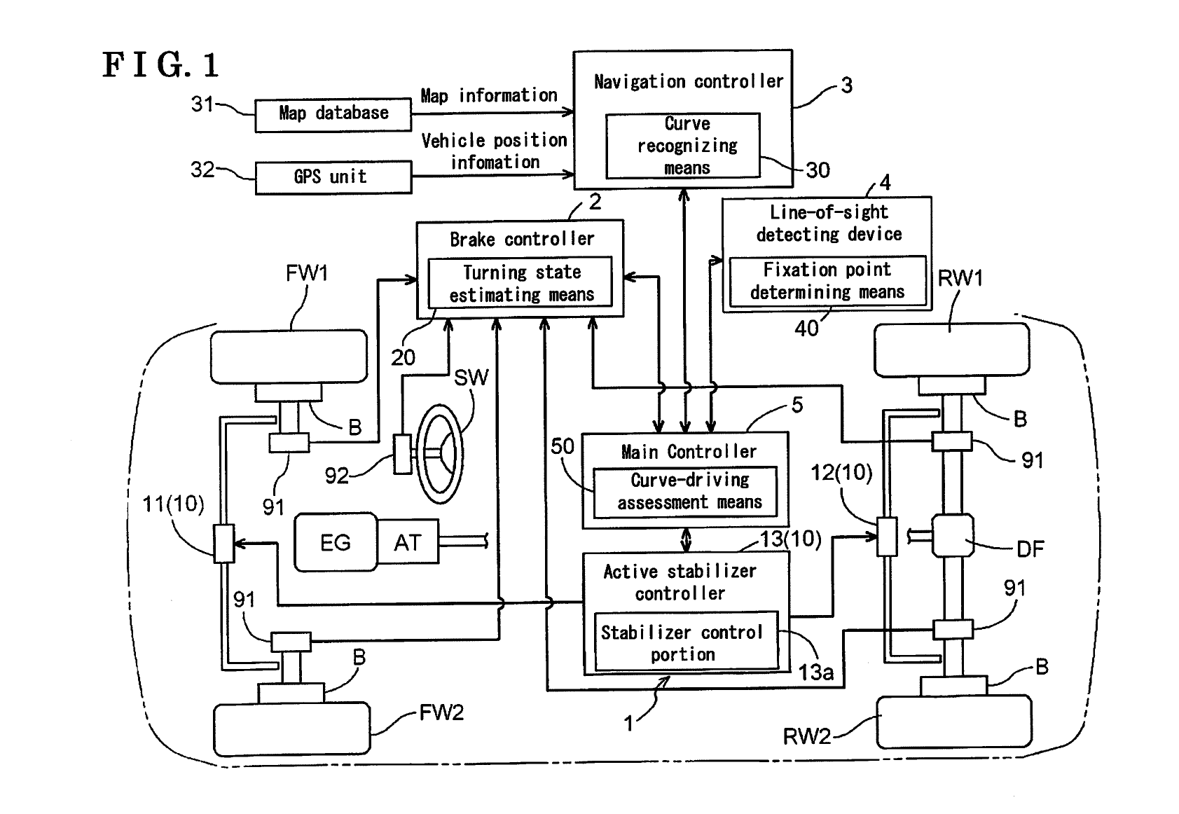

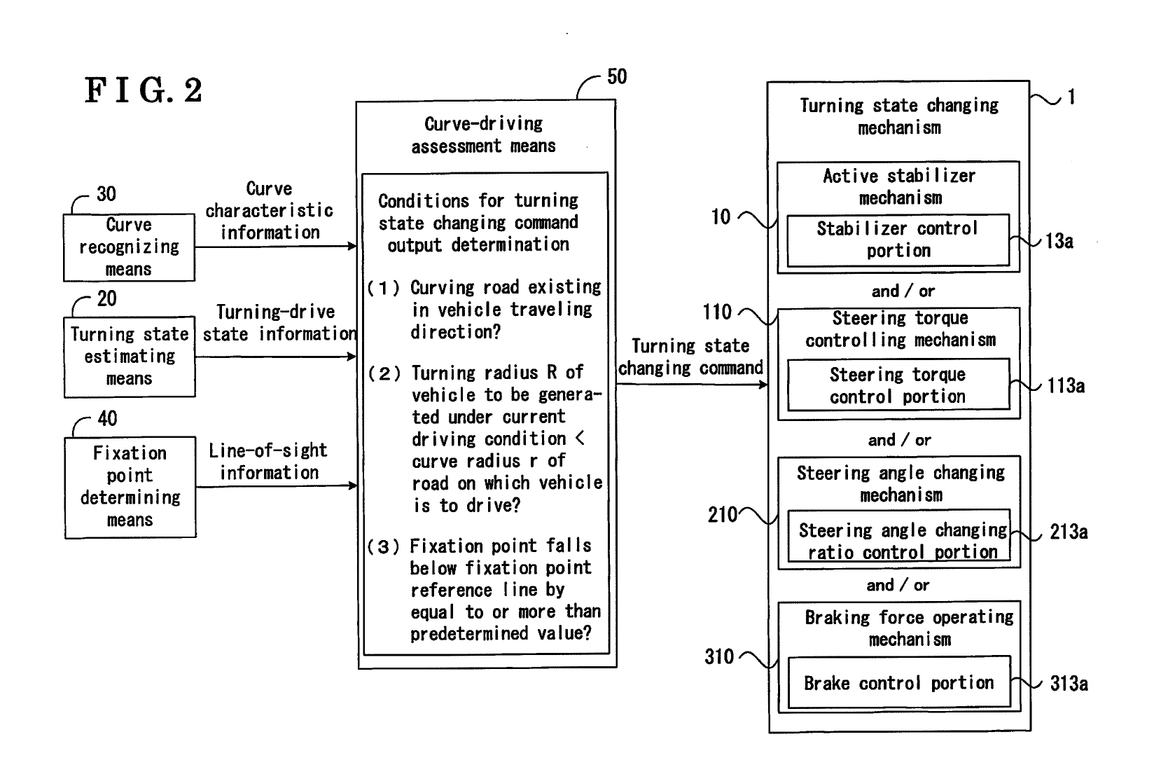

Illustrated in FIG. 1 is a first embodiment of the vehicle control device. Further, illustrated in FIG. 1 is an example of a schematic configuration of the entire vehicle control device, including a driving system and a steering system. Illustrated in FIG. 2 is an example of a functional block diagram of the vehicle control device. As illustrated in FIG. 1, a power generated at an engine EG is transmitted to a differential apparatus DF via, for example, an automatic transmission AT. Then, the power is further transmitted to a rear-right wheel RW1 and a rear-left wheel RW2 from the differential apparatus DF via right and left rear axles, respectively. An operation angle of a steering wheel SW is transmitted to a front-right wheel FW1 and a front-left wheel FW2 as a steering angle thereof via an electric power steering system, thereby steering the vehicle. A brake B is provided at each of the front-right wheel FW1, front-left wheel FW2, rear-right wheel RW1 and rear-left wheel RW2. The brakes B are provided at the corresponding wheels so as to be operated independently of one another.

The vehicle includes an active stabilizer mechanism 10 (an example of a steering characteristic adjusting mechanism), which includes an active stabilizer actuator 11 provided at a front-wheel side and an active stabilizer actuator 12 provided at a rear-wheel side. A stabilizer control portion 13a for controlling a stabilizer value indicative of a control variable at the active stabilizer mechanism 10 is provided at an active stabilizer controller 13. As is known, a turning state of the vehicle is changeable by controlling the stabilizer value via the stabilizer control portion 13a. The active stabilizer mechanism 10 is an example of a turning state changing mechanism 1.

Furthermore, the vehicle includes speed sensors 91 for detecting speed of the corresponding front-right wheel FW1, front-left wheel FW2, rear-right wheel RW1 and rear-left wheel RW2, respectively, and an operation angle sensor 92 for detecting the operation angle of the steering wheel SW, as a sensor for detecting a state of the vehicle. In this embodiment, the speed sensors 91 and the operation angle sensor 92 are connected to a brake controller 2, which controls the brakes B. A turning state estimating means 20 for outputting a turning radius of the vehicle, which is estimated on the basis of the wheel speed and the operation angle, as a turning-drive state information of the vehicle, is included within the brake controller 2. The turning radius R of the vehicle is estimated by, for example, the following equation at the turning state estimating means 20.

R=(1+A·V²)·L·N/θ

where “θ” indicates the operation angle of the steering wheel SW, “L” indicates a wheel base, “N” indicates a steering gear ratio and “A” indicates a steering characteristic coefficient, which is obtained on the basis of the stabilizer value of the active stabilizer mechanism 10.

A car navigation system is also provided to the vehicle. In this embodiment, a known car navigation system is adapted. More specifically, the vehicle includes the car navigation system that includes a navigation controller 3, a map database 31 for providing a map data to the navigation controller 3, and a global positioning system unit (GPS unit) 32 for providing a vehicle position information (information relating to a position of the vehicle to which the navigation system is mounted) to the navigation controller 3. Additionally, in order to obtain further accurate vehicle position, an azimuth information obtained from an azimuth sensor, such as a gyro sensor and the like, and a traveling distance information obtained from a distance sensor (the speed sensors 91 may be used also as the distance sensor) are also provided to the navigation controller 3. A curve recognizing means 30 for generating and outputting a shape information such as a curve radius of a curve existing in a traveling direction of the vehicle as a curve characteristic information is included in the navigation controller 3.

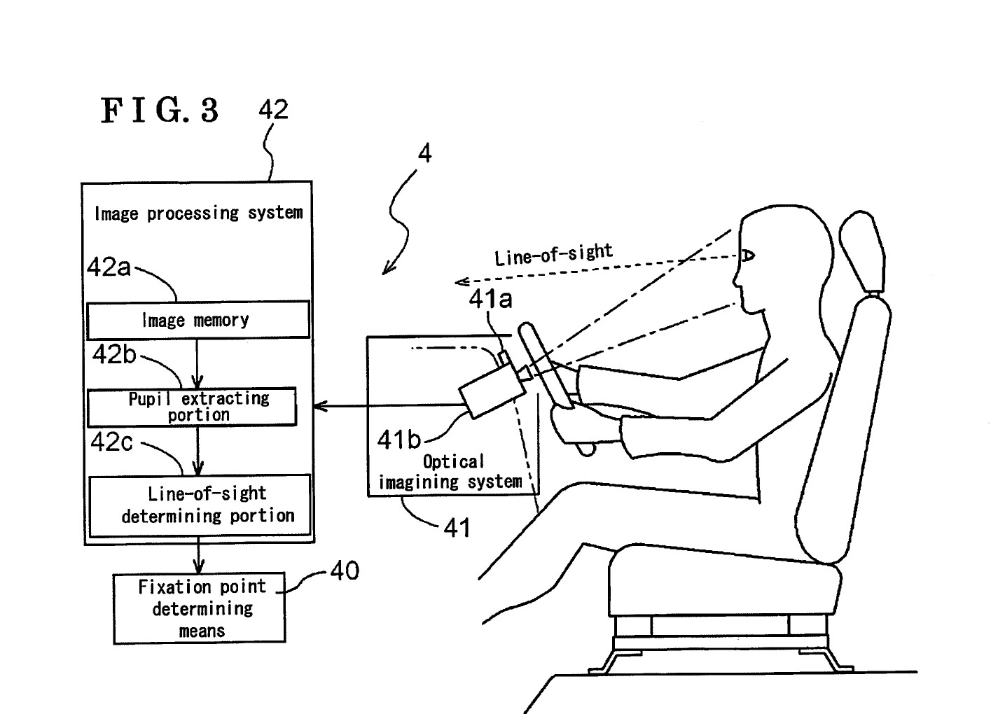

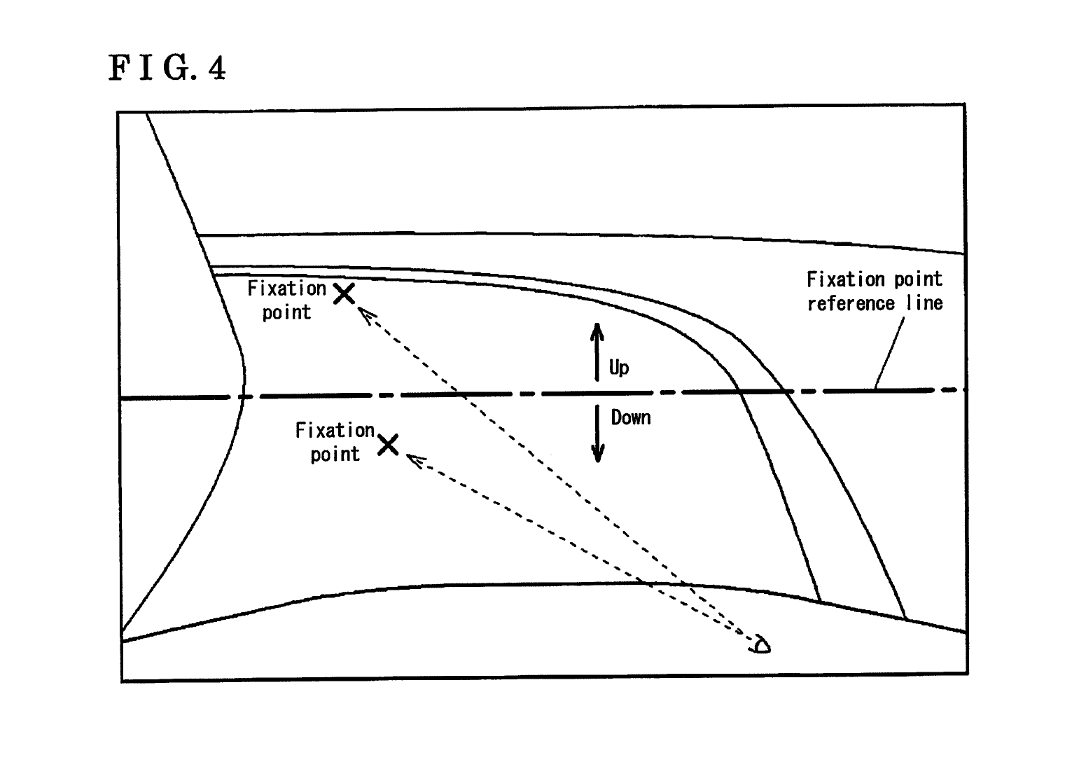

As illustrated in FIG. 3, a line-of-sight detecting device 4 includes a line-of-sight determining means 40, an optical imagining system 41 and an image processing system 42. The optical imagining system 41 is configured by an infrared emitting portion 41a, which is provided so as to illuminate a face area of a driver seated on a driver's seat, an image capturing portion 41b having an auto-focus function, which is set so as to capture an image of the face area of the driver being illuminated by the infrared emitting portion 41a, and the like. The image processing system 42 is configured by an image memory 42a, in which the captured image data being transferred thereto from the image capturing portion 41b is developed, a pupil extracting portion 42b for extracting a pupil area from an eye area detected by an eye detection process, which is executed relative to the developed captured image data, following a face detection process, and a line-of-sight direction determining portion 42c for determining a line-of-sight (an eye direction) of the driver on the basis of a position of the pupil area in a spatial coordinate system on the captured image and a posture (position) of the driver in a spatial coordinate system of the vehicle. The line-of-sight determining means 40 determines a point of the line-of-sight (the eye direction) of the driver fixed at a road surface or a landscape extending in the vehicle traveling direction, i.e. an image-forming point of the line-of-sight (i.e. fixation point), on the basis of the line-of-sight direction (i.e. the eye direction) determined at the line-of-sight direction determining portion 42c. Then, the line-of-sight determining means 40 obtains a deviation of the determined fixation point in an up-and-down direction (i.e. a vertical direction) relative to a fixation point reference line, which is preliminarily set as a reference level, and outputs a line-of-sight information. As illustrated in FIG. 4, the fixation point reference line refers to a line indicating a height level of the fixation point of an average driver during a normal driving. In a case where the obtained fixation point is positioned below the fixation point reference line, it indicates that the driver tends to perform a myopic driving (i.e. a driving while keeping his/her focus short), more specifically, it indicates that the driver tends to steer the steering wheel towards a turning inner side of, for example, the curve while the vehicle travels through the curve, which may result in deviating the vehicle from the road (traveling route). Therefore, the line-of-sight information includes a fixation point determination result indicating whether or not the obtained fixation point is positioned below the fixation point reference line. Furthermore, a deviation value of the fixation point, indicative of a deviation between the fixation point reference line and the fixation point positioned below the fixation point reference line, may be included in the line-of-sight (eye direction) information, if needed.

As is evident from FIG. 2, a curve-driving assessment portion 50 (a curve-driving assessment means), which is constructed within a main controller 5 of the vehicle control device, is connected to the stabilizer control portion 13a, the curve recognizing means 30, the turning state estimating means 20 and the line-of-sight determining means 40. The curve-driving assessment portion 50 is configured so as to receive the curve radius of the curve on the road, on which the vehicle is to travel, from the curve recognizing means 30 as the curve characteristic information of the curve existing ahead of the vehicle in the traveling direction, the turning radius of the vehicle to be generated when the vehicle travels through the curve under a current driving condition from the turning state estimating means 20 as the turning-drive state information of the vehicle, and the fixation point determination result and the deviation value from the line-of-sight determining means 40 as the line-of-sight information relating to the line-of-sight (the eye direction) of the driver. The curve-driving assessment portion 50 subjects the received information to a predetermined condition, so that in a case where it is anticipated that the vehicle may deviate from the road surface, on which the vehicle is to travel, when maintaining the current driving condition, and further, in a case where it is assumed that the driver performs the myopic driving without ease, the curve-driving assessment portion 50 outputs a turning state changing command to the stabilizer control portion 13a of the active stabilizer mechanism 10, which is used as an example of the turning state changing mechanism 1 in the first embodiment, so as to change the turning state of the vehicle, such as the state where the vehicle is expected to deviate from the road surface, in order to prevent the vehicle from deviating from the road surface.

Described below are conditions for the turning state changing command output determination used in the curve-driving assessment portion 50.

Condition 1: whether or not the curve exists ahead of the vehicle in the vehicle traveling direction;
Condition 2: whether or not the vehicle turning radius R to be generated when the vehicle travels through the curve under the current driving condition is less than a curve radius r of the road surface on which the vehicle is to travel (i.e. whether or not a relationship “R<r” is satisfied); and
Condition 3: whether or not the fixation point is lower than the fixation point reference line by equal to or greater than a predetermined value.

In a case where all three conditions (Condition 1, Condition 2 and Condition 3) are satisfied, it may be assumed that a driving skill of the driver is insufficient and the turning radius of the vehicle becomes smaller than the curve radius. Therefore, in this case, the curve-driving assessment portion 50 outputs the turning state changing command to the turning state changing mechanism 1 so as to increase the turning radius of the vehicle.

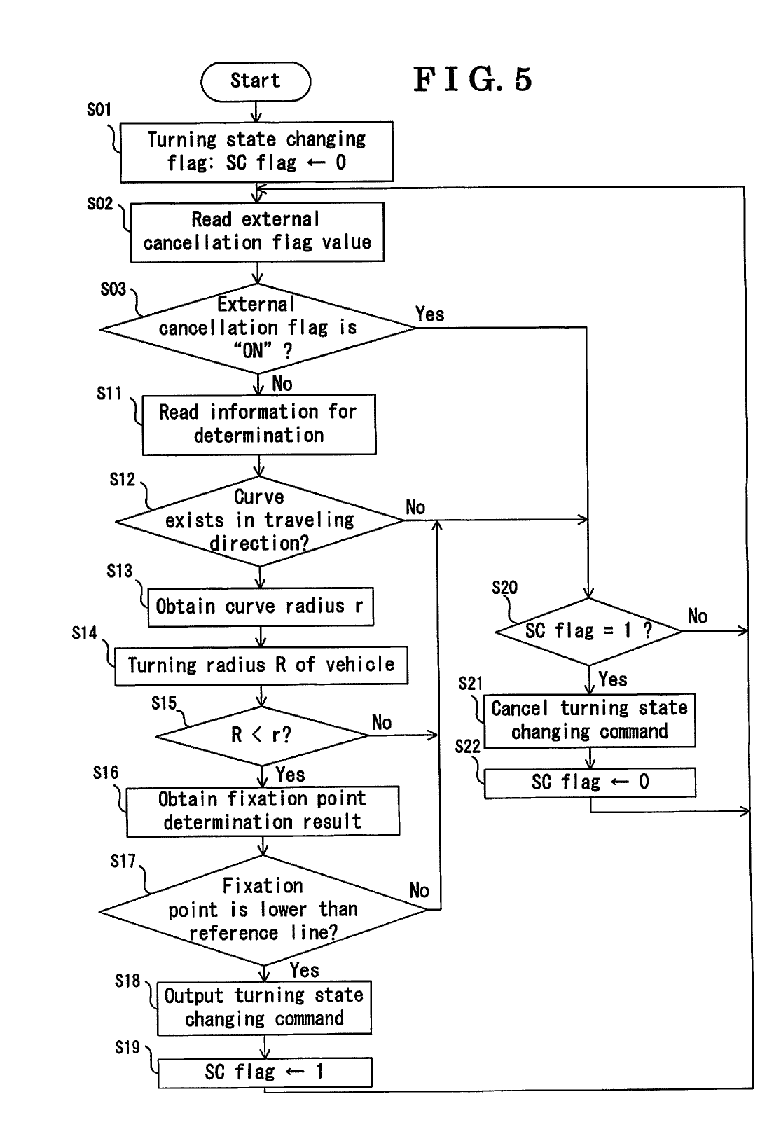

An example of a control process in the vehicle control device having the above-described configuration will be explained below with reference to a flowchart illustrated in FIG. 5. Firstly, as an initialization process, the turning state changing flag (SC flag) is set to zero (0) (step S01). Then, a value at an external cancellation flag is read (step S02) in order to check whether or not the external cancellation flag is “ON” (step S03). The external cancellation flag is a flag that turns to be “ON” for forcibly canceling the control process while the vehicle is traveling through the curve in a case where the driver performs an operation exceeding a reference level. For example, the external cancellation flag is turned “ON” in a case where the driver recognizes a probability of the vehicle deviating from the road surface and performs an emergency avoidance operation of the steering wheel, a brake pedal and the like as an avoidance action, or in a case where the driver performs an operation such as depressing an acceleration pedal strongly on the curve for a specific driving such as a drift driving and the like.

Then, information for determination used for the calculation (determination) of the above-described conditions (Condition 1, Condition 2 and Condition 3) is read into the turning-drive assessment portion 50 (step S11). The information for determination to be read includes the curve characteristic information inputted into the curve-driving assessment portion 50 from the curve recognizing means 30, the turning-drive state information inputted from the turning state estimating means 20 and the line-of-sight information inputted from the line-of-sight determining means 40. The vehicle control device executes a vehicle control while the vehicle travels through the curve. Therefore, the vehicle control device checks whether or not the curve exists ahead of the vehicle in the vehicle traveling direction on the basis of the read curve characteristic information (step S12). In a case where the curve exists ahead of the vehicle in the vehicle traveling direction (Yes in step S12), the curve-driving assessment portion 50 reads the curve radius r of the curve, which exists ahead of the vehicle in the vehicle traveling direction and which is included in the curve characteristic information (step S13). Further, the curve-driving assessment portion 50 reads the turning radius R of the vehicle, which is included in the turning-drive state information estimated by the turning state estimating means 20 and which is to be generated in a case where the vehicle travels through the curve under the current driving condition (step S14). Then, the curve-driving assessment portion 50 compares the turning radius R of the vehicle with the curve radius r of the road in order to check whether or not the turning radius R of the vehicle is smaller than the curve radius r of the road (step S15). In a case where the turning radius R of the vehicle is smaller than the curve radius r of the road (Yes in step S15), the vehicle may deviate from an inner end portion of the curve road surface if the vehicle travels through the curve under the current driving condition. A need thus exists to determine whether the driver intentionally conducts a positioning on the curve surface with the intention of a sporty driving or such positioning on the curve occurs unintentionally because of insufficient driving skill of the driver. Therefore, the fixation point determination result, which is included in the line-of-sight information and which includes the result of whether or not the obtained fixation point of the driver positioned below the fixation point reference line, is used. As described above, in the case where the fixation point of the driver is positioned below the fixation point reference line, it is determined that the driver performs the myopic driving and it may cause a danger if the vehicle approaches/travels through the curve under the current driving condition. Therefore, the curve-driving assessment portion 50 reads the fixation point determination result (step S16) in order to check whether or not the fixation point of the driver is positioned below the fixation point reference line (step S17). In the case where the fixation point of the driver is positioned below the fixation point reference line (Yes in step S17), the curve-driving assessment portion 50 determines that the current turning state of the vehicle is less likely to be changed by the driver. Then, in this case, the curve-driving assessment portion 50 outputs the turning state changing command to the stabilizer control portion 13a, which serves as the turning state changing mechanism 1 (step S18).

The stabilizer control portion 13a, which receives the turning state changing command, controls the stabilizer value of the active stabilizer mechanism 10 in order to generate further under-steering state at the vehicle than the current vehicle condition. For example, in a case where the vehicle is currently in a slight under-steering state, the stabilizer control portion 13a controls the stabilizer value of the active stabilizer mechanism 10 in order to generate a stronger under-steering state at the vehicle. Further, in a case where the vehicle is currently in the strong over-steering state, the stabilizer control portion 13a controls the stabilizer value of the active stabilizer mechanism 10 in order to change to a weaker over-steering state. Still further, in a case where the vehicle is currently in the slight over-steering state, the stabilizer control portion 13a controls the stabilizer value of the active stabilizer mechanism 10 in order to change to a slight under-steering state. The control of the active stabilizer mechanism 10 by the stabilizer control portion 13a is separately executed by a different control process from the control process described above.

When the turning state changing command is outputted to the stabilizer control portion 13a, the turning state changing flag is set to one (1) (step S19). Therefore, the turning state changing flag being one (1) indicates that the control for changing the vehicle condition to the under-steering condition is being executed to the active stabilizer mechanism 10 regardless of whether the vehicle is currently in the under-steering condition or in the over-steering condition. After one (1) is set in the turning state changing flag, the process returns to step S02.

On the other hand, it is determined that the vehicle is not likely to deviate from the inner end portion of the curved road surface in a case where it is determined that the curve does not exist ahead of the vehicle in the vehicle traveling direction in step S12 (No in step S12), in a case where the turning radius R of the vehicle is determined to be equal to or greater than the curve radius r of the road in step S15 (No in step S15), or in a case where it is determined that the fixation point of the driver is positioned equal to or above the fixation point reference line in step S17 (No in step S17). In these cases, firstly, a state of the turning state changing flag is checked (step S20). Then, in a case where the turning state changing flag is zero (0) (No in step S20), the turning state changing process is not executed by the stabilizer control portion 13a. Therefore, in this case, the process returns to step S02. On the other hand, in a case where the turning state changing flag is one (1) (Yes in step S20), the turning state changing process is executed by the stabilizer control portion 13a. Therefore, the curve-driving assessment portion 50 outputs a turning state change aborting command to the stabilizer control portion 13a, which serves as the turning state changing mechanism 1, in order to cancel the steering change command (step S21). Accordingly, the turning state changing process executed by the stabilizer control portion 13a is cancelled. Then, the turning state changing flag is set to zero (0) (step S22) and the process is returned to step S02.

Additionally, in the above-described control process, the fixation point determination of whether or not the fixation point of the driver is positioned below the fixation point reference line is executed at step S17. Then, the steering change command for executing the turning state changing process (i.e. for turning on the turning state changing process) is outputted to the active stabilizer controller 13 at step S18 depending on the determination result. Alternatively, the control process may be modified so as to add intensity of changing (i.e. level of changing) to the steering change command in response to a level (degree) of the fixation point falling below the fixation point reference line (i.e. the deviation between the fixation point and the fixation point reference line) in a case where the line-of-sight information includes the downward deviation value between the fixation point reference line and the fixation point of the driver positioned below the fixation point reference line in addition to the fixation point determination result of whether or not the fixation point of the driver is positioned below the fixation point reference line. In other words, in this case, the vehicle control device may be configured so as to require the steering state changing process in a manner where the lower the fixation point is positioned relative to the fixation point reference line (i.e. the greater the deviation value is), the greater value the stabilizer value of the active stabilizer mechanism 10 is changed to be.

### Second Embodiment

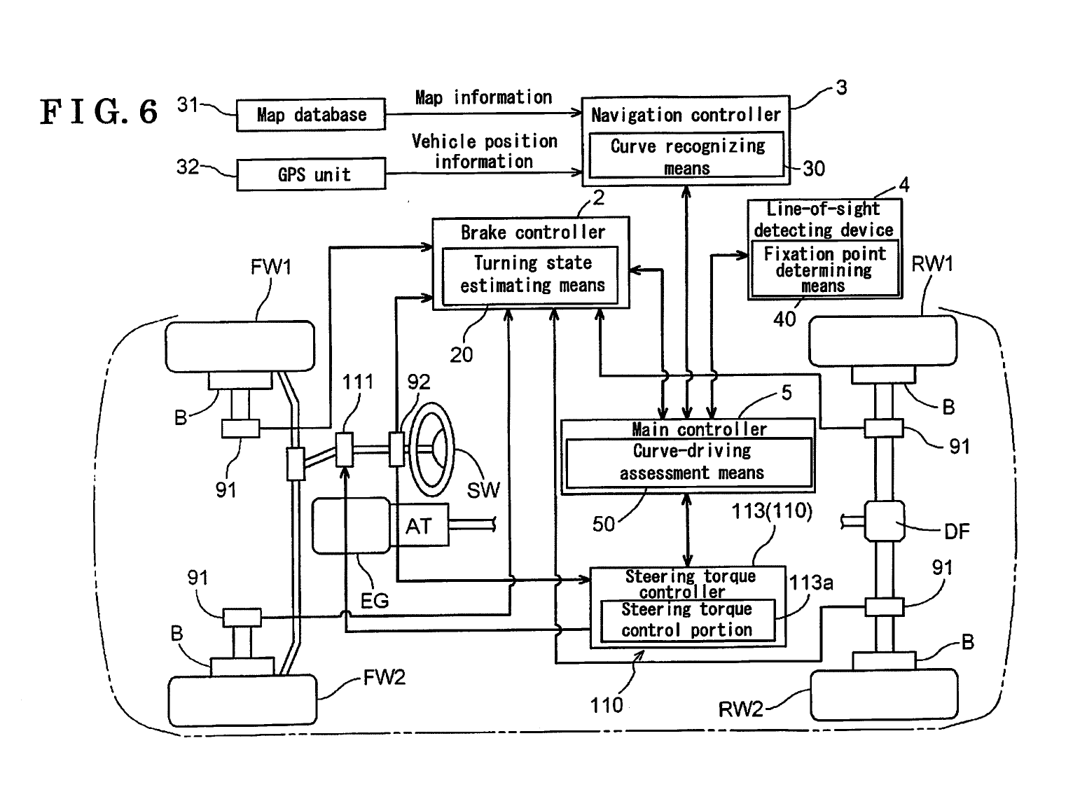

A second embodiment of a vehicle control device will be described below in accordance with FIG. 6. Illustrated in FIG. 6 is an example of an entire configuration of the vehicle control device according to the second embodiment. Further, the entire configuration of the vehicle control device illustrated in FIG. 6 corresponds to the entire configuration of the vehicle control device of the first embodiment illustrated in FIG. 1. The vehicle control device of the second embodiment differs from the first embodiment in that a steering torque controlling mechanism 110 is used as the turning state changing mechanism 1 in the second embodiment. The steering torque controlling mechanism 110 includes a power steering unit 111 (a steering mechanism) and a steering torque controller 113. The power steering unit 111 applies the steering torque to a front-wheel steering system from an auxiliary power source such as an electric motor and the like. The operation angle sensor 92 for detecting the operation angle of the steering wheel SW and the power steering unit 111 are connected to the steering torque controller 113. The steering torque controller 113 includes a steering torque control portion 113a for inputting therein the detection signal from the operation angle sensor 92 and outputting a control signal to the power steering unit 111 so as to apply an appropriate steering torque to the front-wheel steering system.

According to the second embodiment, in the case where all of the three conditions (Condition 1, Condition 2 and Condition 3), which are described in the first embodiment and which are used for the turning state changing command output determination, are satisfied at the curve-driving assessment portion 50, it may be assumed that the turning radius of the vehicle becomes smaller than the curve radius of the curve because of the insufficient driving skill of the driver. Therefore, in this case, the curve-driving assessment portion 50 outputs the turning state changing command to the steering torque control portion 113a of the steering torque controlling mechanism 110 (see step S18 in FIG. 5). The steering torque control portion 113a sends the control signal to the power steering unit 111 so as to reduce the steering angle of the wheels (i.e. so as to increase the turning radius of the vehicle) on the basis of the received turning state changing command. Accordingly, the turning state of the vehicle is changed so as to increase the turning radius of the vehicle in order to prevent the vehicle from deviating from the road because of the myopic driving of the driver having the insufficient driving skill.

### Third Embodiment

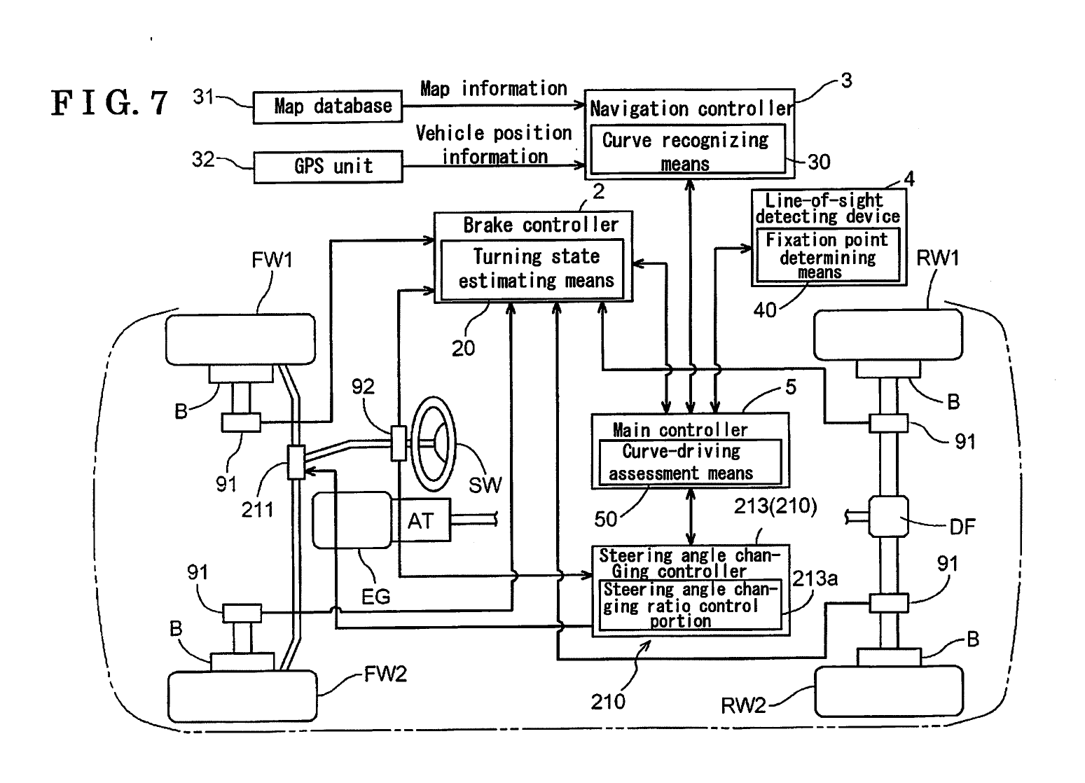

A third embodiment of a vehicle control device will be described below with reference to FIG. 7. Illustrated in FIG. 7 is an example of an entire configuration of the vehicle control device according to the third embodiment. Further, the entire configuration of the vehicle control device illustrated in FIG. 7 corresponds to the entire configuration of the vehicle control device of the first embodiment illustrated in FIG. 1. The vehicle control device of the third embodiment differs from the vehicle control device of the first and second embodiments in that a steering angle changing mechanism 210 is used as the turning state changing mechanism 1. The steering angle changing mechanism 210 includes a steering angle changing ratio variable unit 211 and a steering angle changing controller 213. The steering angle changing ratio variable unit 211 is incorporated into the front-wheel steering system. Further, the steering angle changing ratio variable unit 211 includes a motor and a reduction mechanism provided on a steering shaft, which connects the steering wheel SW with the front wheels FW1 and FW2. A known steering angle changing ratio variable unit 211, which is disclosed in, for example, JPH11-34894A, is adapted in this embodiment. By providing a control signal to the motor, a steering operation based on a predetermined steering angle changing ratio is achieved. The operation angle sensor 92 for detecting the operation angle of the steering wheel SW and the steering angle changing ratio variable unit 211 are connected to the steering angle changing controller 213. The steering angle changing controller 213 includes a steering angle changing ratio control portion 213a for inputting therein the detection signal from the operation angle sensor 92 and outputting a control signal to the steering angle changing ratio variable unit 211 so as to generate an appropriate steering angle at the front wheels FW1 and FW2.

According to the third embodiment, in the case where all of the three conditions (Condition 1, Condition 2 and Condition 3), which are described in the first embodiment and which are used for the turning state changing command output determination, are satisfied at the curve-driving assessment portion 50, it may be assumed that the turning radius of the vehicle becomes smaller than the curve radius of the curve because of the insufficient driving skill of the driver. Therefore, in this case, the curve-driving assessment portion 50 outputs the turning state changing command to the steering angle changing ratio control portion 213a of the steering angle changing mechanism 210 (see step S18 in FIG. 5). The steering angle changing ratio control portion 213a sends the control signal to the steering angle changing ratio variable unit 211 so as to reduce the steering angle of the wheels (i.e. so as to increase the turning radius of the vehicle) on the basis of the received turning state changing command. Accordingly, the turning state of the vehicle is changed so as to increase the turning radius of the vehicle, thereby preventing the vehicle from deviating from the road because of the myopic driving of the driver having the insufficient driving skill.

### Fourth Embodiment

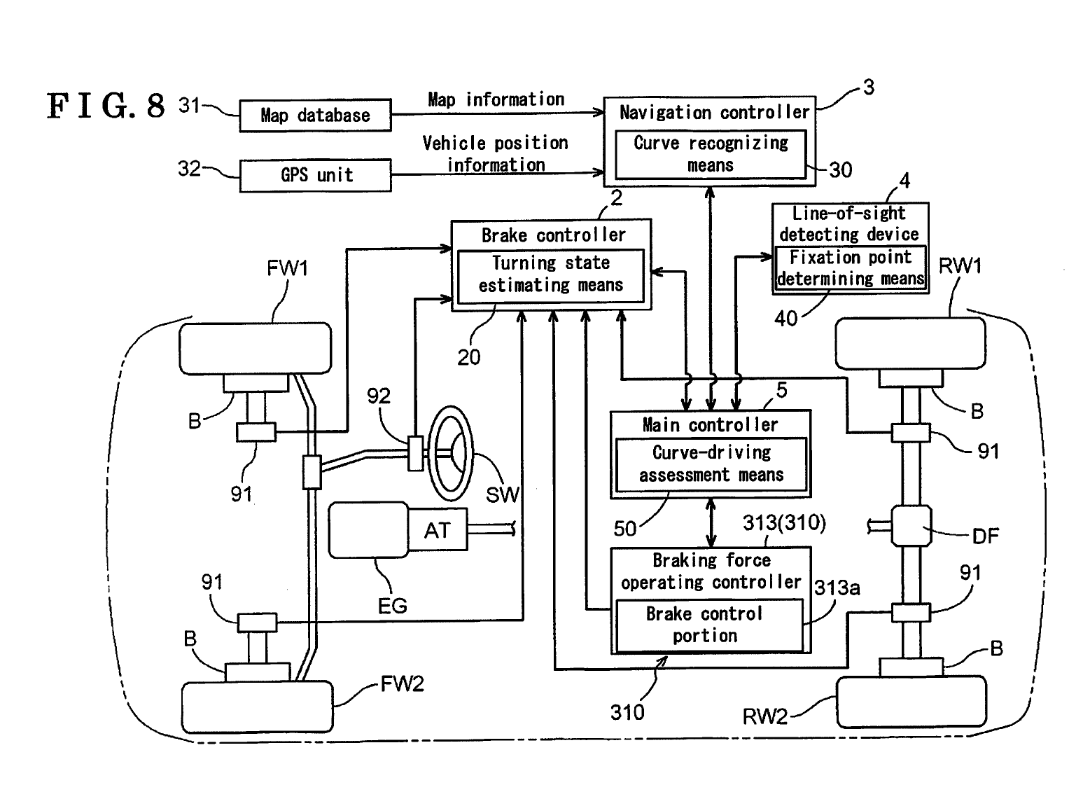

A fourth embodiment of a vehicle control device will be described below with reference to FIG. 8. Illustrated in FIG. 8 is an example of an entire configuration of the vehicle control device according to the fourth embodiment. Further, the entire configuration of the vehicle control device illustrated in FIG. 8 corresponds to the entire configuration of the vehicle control device of the first embodiment illustrated in FIG. 1. The vehicle control device of the fourth embodiment differs from the vehicle control device of the other embodiments in that a braking force operating mechanism 310 is used as the turning state changing mechanism 1. The braking force operating mechanism 310 is a brake system mounted on the vehicle. Furthermore, the braking force operating mechanism 310 controls the brake controller 2 so as to appropriately operate the brakes B in response to a level of the depression of the brake pedal, detection of a slip state of the vehicle generated while the vehicle is traveling, and the like. Therefore, a braking force operating controller 313, serving as a controller for the braking force operating mechanism 310 (see FIG. 8), may be achieved by using the brake controller 2. However, in the fourth embodiment, the braking force operating controller 313 is separately provided to the vehicle control device in order to describe a different configuration from the above-described embodiments. In the fourth embodiment, a brake control portion 313a, included in the braking force operating controller 313, provides a control signal to the brake controller 2 on the basis of the turning state changing command outputted from the curve-driving assessment means 50 so as to change the turning state of the vehicle (e.g. so as to increase the turning radius of the vehicle) by operating the brakes B of the front-right wheel FW1, front-left wheel FW2, rear-right wheel RW1 and rear-left wheel RW2 independently of each other.

According to the fourth embodiment, in the case where all of the three conditions (Condition 1, Condition 2 and Condition 3), which are described in the first embodiment and which are used for the turning state changing command output determination, are satisfied at the curve-driving assessment portion 50, it may be assumed that the turning radius of the vehicle becomes smaller when comparing to the curve radius of the curve because of the insufficient driving skill of the driver. Therefore, in this case, the curve-driving assessment portion 50 outputs the turning state changing command to the brake control portion 313a of the braking force operating mechanism 310 (see step S18 in FIG. 5). The brake control portion 313a sends a control signal to the brake controller 2 on the basis of the received turning state changing command so as to execute the brake operation of, for example, increasing the turning radius of the vehicle. Accordingly, the turning state of the vehicle is changed so as to increase the turning radius of the vehicle, thereby preventing the vehicle from deviating from the road because of the myopic driving of the driver having the insufficient driving skill.

### Other Embodiments

(1) In the above-described embodiments, either one of the active stabilizer mechanism 10, the steering torque controlling mechanism 110, the steering angle changing mechanism 210 and the braking force operating mechanism 310 is used as the turning state changing mechanism 1 to which the turning state changing command is provided from the curve-driving assessment portion 50. However, the vehicle control device may be modified so that the turning state changing mechanism 1 is configured by combining any desired two or more of the active stabilizer mechanism 10, the steering torque controlling mechanism 110, the steering angle changing mechanism 210 and the braking force operating mechanism 310 or by using all of the active stabilizer mechanism 10, the steering torque controlling mechanism 110, the steering angle changing mechanism 210 and the braking force operating mechanism 310.

(2) In the above-described embodiments, the curve-driving assessment portion 50, the active stabilizer controller 13, the steering torque controller 113, the steering angle changing controller 213 and the braking force operating controller 313 of the turning state changing mechanism 1, to which the turning state changing command is provided from the curve-driving assessment portion 50, are separately and independently configured as illustrated in the functional blocks. However, the vehicle control device may be modified so as to integrate the curve-driving assessment portion 50, the steering torque controller 113, the steering angle changing controller 213 and the braking force operating controller 313 of the turning state changing mechanism 1. The vehicle control device has the configurations illustrated in the functional block diagrams of FIGS. 1, 6, 7 and 8 in which each function is separately illustrated in order to facilitate the explanation of the vehicle control device. However, the actual configuration of the vehicle control device is not limited to the configurations illustrated in the drawings.

(3) The fixation point reference line (i.e. the reference level), which is used at the fixation point determining means 40 of the line-of-sight detecting device 4, is preliminarily set. However, the fixation point reference line may preferably be set for the driver. Additionally, it may be preferable if the fixation point reference line is adjusted in response to a seat position (e.g. a posture of the seat) and the like. Furthermore, the fixation point reference line may be obtained on the basis of an average position of the fixation point of the driver while the vehicle travels straight.

(4) In the above-described embodiments, the curve-driving assessment portion 50 outputs the turning state changing command to the turning state changing mechanism 1 on the basis of the curve characteristic information, the turning-drive state information and the line-of-sight information. However, the turning-drive state information is not an essential condition. Therefore, the vehicle control device may be modified so that the curve-driving assessment portion 50 outputs the turning state changing command to the turning state changing mechanism 1 on the basis of the curve characteristic information and the line-of-sight information.

Accordingly, the curve-driving assessment portion 50 assesses a condition of the road surface of the curve, through which the vehicle is to travel, on the basis of the curve characteristic information. Furthermore, the curve-driving assessment portion 50 is configured so as to obtain the information relating to the fixation point of the driver, by which it is determined whether the skilled driver performs a sporty driving on the curve or the driver performs myopic driving on the curve, which may cause a danger, because of the insufficient driving skill, on the basis of the line-of-sight information. Therefore, the curve-driving assessment portion 50 outputs the turning state changing command to the turning state changing mechanism 1 after the curve-driving assessment portion 50 assesses a degree of risk (i.e. the probability of the vehicle deviating from the road surface) on the basis of the curve road surface condition, which is obtained from the curve characteristic information and the driving characteristic of the driver. As a result, unnecessary steering adjustment is prevented from being executed to the vehicle in the case where the driver intentionally performs the sporty driving on the curve. On the other hand, an appropriate steering adjustment is executed to the vehicle in the case where the driver performs the myopic driving on the curve, which may cause a danger.

According to the embodiments, the curve-driving assessment portion 50 inputs therein the turning-drive state information of the vehicle in order to use the turning-drive state information for determining the output of the turning state changing command.

Accordingly, the curve-driving assessment portion 50 is configured so as to assess a possibility of the vehicle, traveling through the curve, deviating from the road surface on the basis of the curve characteristic information and the turning-drive state information. Therefore, the curve-driving assessment portion 50 outputs the turning state changing command to the turning state changing mechanism 1 after assessing the degree of risk (i.e. the possibility of the vehicle deviating from the road surface) on the basis of the driving characteristic of the driver, even in the case where the vehicle control device determines that the vehicle may deviate from the road surface on the basis of the curve characteristic information and the turning-drive state information.

In order to promptly and easily execute the determination of whether the driver performs the sporty driving on the curve or the driver performs the myopic driving on the curve, which may cause a danger, at the curve-driving assessment portion 50 by using the line-of-sight information, the determination of whether or not the fixation point, which is included in the line-of-sight information, is positioned above or below the reference level, is used. The fixation point is defined as a point at which the line-of-sight (the eye direction) of the driver is fixed on the road surface, the landscape and the like extending in the vehicle traveling direction, i.e. the image forming point of the line-of-sight. The position of the fixation point of the driver with reference to the reference level while driving the vehicle generally relates to a calmness (ease) of the driver. For example, if the driver drives the vehicle with ease, the driver is likely to look ahead in the distance, which may result in positioning the fixation point of the driver at a relatively upper position with reference to the reference level (i.e. the fixation point reference line). On the other hand, if the driver drives the vehicle with less ease, the driver tends to look in the foreground (i.e. the driver tends to keep his/her focus short), which may result in positioning the fixation point of the driver at a relatively low position with reference to the reference level (i.e. the fixation point reference line). Specifically, in the case where the fixation point of the driver is positioned below the reference level when approaching to/traveling through the curve, it may be assumed that the turning state of the vehicles is in a state where the vehicle tends to move towards an inner side of the vehicle. Therefore, in this case, the vehicle may need to be controlled so that the turning state of the vehicle shifts to a state where the vehicle is outwardly steered relative to the current turning state.

According to the embodiments, the curve-driving assessment portion 50 uses the position of the fixation point of the driver, included in the line-of-sight information, with reference to the reference level as one of determination conditions for outputting the turning state changing command, so that in the case where the fixation point of the driver is positioned below the reference level, the curve-driving assessment portion 50 determines that the vehicle moves towards the inner side of the curve and therefore, the curve-driving assessment portion 50 outputs the turning state changing command so that the turning state changing mechanism 1 changes the turning state of the vehicle to the turning state where the turning radius of the vehicle increases.

Accordingly, the vehicle is prevented from deviating from the road, which may occur because of the myopic driving performed by the driver having insufficient driving skill.

According to the embodiments, the curve-driving assessment portion 50 uses the comparison between the curve radius r of the road, included in the curve characteristic information, and the turning radius R of the vehicle, included in the turning-drive state information, as one of the determination conditions for outputting the turning state changing command.

Accordingly, an extending shape of the curved road may be compared with a driving path, which is to be formed by the vehicle traveling on the curved road, so that the vehicle control device assesses whether or not the vehicle, traveling on the curved road, is to deviate from the road surface. Accordingly, the assessment result may be used as one of the determination conditions for whether or not the curve-driving assessment portion 50 outputs the turning state changing command to the turning state changing mechanism 1.

According to the first embodiment, the vehicle control device includes the active stabilizer mechanism 10 (the steering characteristic adjusting mechanism) for adjusting the steering characteristic of the vehicle as the turning state changing mechanism 1.

Accordingly, in the case where the curve-driving assessment portion 50 determines that the vehicle is likely to deviate from the road surface if the vehicle travels through the curve under a current steering condition, the curve-driving assessment portion 50 provides turning state changing command to the active stabilizer mechanism 10 in order to adjust a steering characteristic of the vehicle so that the vehicle does not deviate from the road surface.

According to the first embodiment, the steering characteristic adjusting mechanism includes the active stabilizer mechanism and the stabilizer control portion 13a for controlling the stabilizer values applied relative to the front wheel side and the rear wheel side of the vehicle in the active stabilizer mechanism 10.

According to the vehicle having the active stabilizer mechanism 10, the turning state changing mechanism 1 is easily achieved by configuring the vehicle control device so as to provide the turning state changing command to a control input portion of the stabilizer control portion 13a.

According to the second embodiment, the vehicle control device includes the steering torque controlling mechanism 110 for controlling the steering torque in the power steering unit 111 as the turning state changing mechanism 1.

Accordingly, the curve-driving assessment portion 50 is configured so as to provide the turning state changing command to the steering torque controlling mechanism 110 so as to directly change the angle of the steered wheels to the angle by which the vehicle is prevented from deviating from the road surface. The steering torque controlling mechanism 110 provides a steering driving force to the steered wheels from an auxiliary power generating source, such as the electric motor and the like, in response to the steering torque applied to the steering shaft. As the angle of the steered wheels are directly changed, the curve-driving assessment portion 50 promptly shifts the turning state of the vehicle, which is assessed to be dangerous, to a normal turning state (steering state).

According to the third embodiment, the vehicle control device includes the steering angle changing mechanism 210 for changing the steering angle of the steered wheels of the vehicle generated by the steering wheel SW as the turning state changing mechanism 1.

The steering angle changing mechanism 210 is a mechanism in which the changing ratio of changing the steering wheel operation angle into the wheel steering angle (i.e. the steering angle changing ratio) is set to be variable in response to the driving condition of the vehicle, instead of fixing the ratio between the steering wheel operation angle and the wheel steering angle as, for example, one to one (1:1). Accordingly, the vehicle control device is configured so that the curve-driving assessment portion 50 provides the turning state changing command to the steering angle changing mechanism 210 so as to directly change the angle of the steered wheels to be the angle by which the vehicle remains on the road surface (i.e. the vehicle is prevented from deviating from the road surface). In this case, because the angle of the steered wheels is directly changed, the curve-driving assessment portion 50 promptly shifts the turning state of the vehicle, which is determined to be dangerous, to the normal turning state (i.e. the normal steering state). Furthermore, in the steering angle changing mechanism 210, the steering angle of the steered wheels, which is generated by changing the steering angle changing ratio, is not transmitted to the steering wheel SW. Therefore, the vehicle control device may appropriately adjust the angle of the steered wheels without causing a discomfort to the driver, which may be caused due to the steering wheel being unintentionally operated.

According to the fourth embodiment, the vehicle control device includes the braking force operating mechanism 310 for operating the braking force of each wheel of the vehicle as the turning state changing mechanism 1.

By providing the braking force to the appropriate wheel(s), the vehicle may be changed to be in an under-steering tendency or an over-steering tendency while the vehicle is traveling through the curve. Accordingly, the curve-driving assessment portion 50 is configured to provide the turning state changing command to the braking force operating mechanism 310 in order to change the turning state of the vehicle so as to prevent the vehicle from deviating from the road surface while traveling through the curve. In this case, the vehicle speed is reduced in any case, because the braking force is applied to the wheels. Therefore, the vehicle control device may also enhance safety of the vehicle.

According to the embodiments, in the case where the driver performs the operation exceeding the reference level, the turning state changing operation on the basis of the turning state changing command is cancelled.

The turning state changing operation on the basis of the turning state changing command needs to be cancelled in the case where the driver recognizes the possibility of the vehicle deviating from the road surface and performs the emergency avoidance operation on the steering wheel, the brake pedal and the like as an avoidance operation. Furthermore, the turning state changing operation on the basis of the turning state changing command also needs to be cancelled in the case where the driver strongly depresses the acceleration pedal on the curve in order to perform a specific operation such as the drift driving and the like. Such operations may result in exceeding a reference level of the operation when comparing to a normal operating state (i.e. a normal driving state). Therefore, the vehicle control device may be modified so that the turning state changing operation based on the turning state changing command is cancelled in the case where the driver performs the operation exceeding the reference level.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle control device comprising:
a turning state changing mechanism for changing a turning state of a vehicle on the basis of a turning state changing command, and
a curve-driving assessment means for inputting therein a curve characteristic information including a shape of a curve existing in a traveling direction of the vehicle and a line-of-sight information relating to a line-of-sight of a driver and for outputting the turning state changing command to the turning state changing mechanism on the basis of the curve characteristic information and the line-of-sight information.

2. The vehicle control device according to claim 1, wherein the curve-driving assessment means further inputs therein a turning-drive state information of the vehicle in order to use the turning-drive state information for determining an output of the turning state changing command.

3. The vehicle control device according to claim 2, wherein the curve-driving assessment means uses a position of a fixation point of the driver, included in the line-of-sight information, with reference to a reference level as one of determination conditions for outputting the turning state changing command, so that in a case where the fixation point of the driver is positioned below the reference level, the curve-driving assessment means determines that the vehicle moves towards an inner side of the curve and therefore, the curve-driving assessment means outputs the turning state changing command so that the turning state changing mechanism changes a turning state of the vehicle to a turning state where a turning radius of the vehicle increases.

4. The vehicle control device according to claim 2, wherein the curve-driving assessment means uses a comparison between a curve radius of the road, included in the curve characteristic information, and a turning radius of the vehicle, included in the turning-drive state information, as one of the determination conditions for outputting the turning state changing command.

5. The vehicle control device according to claim 2 further comprising a steering characteristic adjusting mechanism for adjusting a steering characteristic of the vehicle as the turning state changing mechanism.

6. The vehicle control device according to claim 2 further comprising a steering torque controlling mechanism for controlling a steering torque in a steering mechanism as the turning state changing mechanism.

7. The vehicle control device according to claim 2 further comprising a steering angle changing mechanism for changing a steering angle of a wheel of the vehicle generated by a steering wheel as the turning state changing mechanism.

8. The vehicle control device according to claim 2 further comprising a braking force operating mechanism for operating a braking force of each wheel of the vehicle as the turning state changing mechanism.

9. The vehicle control device according to claim 1, wherein the curve-driving assessment means uses a position of a fixation point of the driver, included in the line-of-sight information, with reference to a reference level as one of determination conditions for outputting the turning state changing command, so that in a case where the fixation point of the driver is positioned below the reference level, the curve-driving assessment means determines that the vehicle moves towards an inner side of the curve and therefore, the curve-driving assessment means outputs the turning state changing command so that the turning state changing mechanism changes a turning state of the vehicle to a turning state where a turning radius of the vehicle increases.

10. The vehicle control device according to claim 9 further comprising a steering characteristic adjusting mechanism for adjusting a steering characteristic of the vehicle as the turning state changing mechanism.

11. The vehicle control device according to claim 9 further comprising a steering torque controlling mechanism for controlling a steering torque in a steering mechanism as the turning state changing mechanism.

12. The vehicle control device according to claim 9 further comprising a steering angle changing mechanism for changing a steering angle of a wheel of the vehicle generated by a steering wheel as the turning state changing mechanism.

13. The vehicle control device according to claim 9 further comprising a braking force operating mechanism for operating a braking force of each wheel of the vehicle as the turning state changing mechanism.

14. The vehicle control device according to claim 1 further comprising a steering characteristic adjusting mechanism for adjusting a steering characteristic of the vehicle as the turning state changing mechanism.

15. The vehicle control device according to claim 14, wherein the steering characteristic adjusting mechanism includes an active stabilizer mechanism and a stabilizer control portion for controlling stabilizer values applied relative to a front wheel side and a rear wheel side of the vehicle in the active stabilizer mechanism.

16. The vehicle control device according to claim 1 further comprising a steering torque controlling mechanism for controlling a steering torque in a steering mechanism as the turning state changing mechanism.

17. The vehicle control device according to claim 1 further comprising a steering angle changing mechanism for changing a steering angle of a wheel of the vehicle generated by a steering wheel as the turning state changing mechanism.

18. The vehicle control device according to claim 1 further comprising a braking force operating mechanism for operating a braking force of each wheel of the vehicle as the turning state changing mechanism.

19. The vehicle control device according to claim 1, wherein in a case where the driver performs an operation exceeding a reference level, a turning state changing operation on the basis of the turning state changing command is cancelled.
